(19) United States
(12) Patent Application Publication
(10) Pub. No.: US 2026/0277952 A1
(43) Pub. Date: Sep. 17, 2026

(54) Methods and Systems for Interactive Electronic Communication

(71) Applicant: SIEMENS AKTIENGESELLSCHAFT, München (DE)

(72) Inventor: Rebecca Johnson, München (DE)

(73) Assignee: SIEMENS AKTIENGESELLSCHAFT, München (DE)

(21) Appl. No.: 19/155,823

(22) PCT Filed: Feb. 1, 2024
(86) PCT No.: PCT/EP2024/052474

§ 371 Date: Aug. 12, 2025

(30) Foreign Application Priority Data
Feb. 13, 2023 (DE) 10 2023 174.3

(51) Int. Cl. G06F 16/3329; G06N 20/00; G06V 40/20; G10L 15/22

(52) U.S. Cl. CPC G06F 16/33295; G06N 20/00; G06V 40/28; G10L 15/22

(57) ABSTRACT

Various embodiments of the teachings herein include methods for interactive electronic communication. An example includes: continuous input from a user to generate interim results including observations of the user; AI-implemented processing the interim results to generate mirroring and/or calibrating questions; generating outputs from the system for interactive electronic communication to the user, each output comprising a respective mirroring and/or calibrating question from element B); communicating the outputs to the user; capturing and storing any response to the outputs by the user; and classifying and assigning the stored responses of the user.

### CROSS-REFERENCE TO RELATED APPLICATIONS

This application is a U.S. National Stage Application of International Application No. PCT/EP2024/052474 filed Feb. 1, 2024, which designates the United States of America, and claims priority to DE Application No. 10 2023 201 174.3 filed Feb. 13, 2023, the contents of which are hereby incorporated by reference in their entirety.

### TECHNICAL FIELD

The present disclosure relates to interactive electronic communication. Various embodiments of the teachings herein include methods for implementing a conversation system and/or chatbot system.

### BACKGROUND

A conversation system—also referred to as a chatbot, for example, below—is a computer-aided system capable of conducting human-like conversations with users. Chatbots are often used in social media, on websites or in instant messaging applications to provide users with information, answer questions or provide services. Chatbots can be programmed in various ways to conduct human-like conversations. Some chatbots use rule-based systems that involve predefined rules and patterns being used to react to user inputs. Other chatbots use machine learning to conduct human-like conversations and improve on the basis of user inputs.

Chatbots can also be used in a large number of branches of industry, for example in customer care, e-commerce and in the entertainment industry. They can help to improve the efficiency of business processes and provide users with a faster and easier option for reacting to their queries and needs.

There are various options for how a chatbot can be trained, depending on how it was programmed. A chatbot that works on the basis of rules is usually programmed by a developer by using predefined rules and patterns to react to user inputs. These rules and patterns are built into the chatbot from the outset. Although this interactive electronic communication conducted by chatbots has been around for some time, it is only through the rapid development of the processing of natural language that chatbots have gained economic significance.

The growing market for bespoke technical solutions requires increasing amounts of knowledge about the customer, their needs and particularly their reactions to products manufactured by mass production and/or on a partly or wholly individualized basis. Customer-specific solutions have a competitive advantage in all walks of life, entirely irrespective of the technology in which they are used, be it health, mobility, nutrition, information, housing, heating, clothing, education, leisure, sport or otherwise.

To produce customer-specificity, it therefore makes sense to acquire as much information as possible about individual customers, for example customer reactions to new products, to classify said information and make it available to product developers as feedback for their work. However, it is impossible in practise to retrieve customer data on a personalized basis, firstly because there is no way of ensuring that a human interlocutor is available at the time of a customer's reaction to the new product and secondly because data collection and classification can be performed less reliably by a human user than by an artificial intelligence. Known chatbots are passive and unable to react to users on an individualized basis.

### SUMMARY

Teachings of the present disclosure include methods and systems for interactive electronic communication that not only request and pass on responses and information but also continually develop themselves further. For example, some embodiments include a computer-implemented method for interactive electronic communication, comprising the following: A) receiving and performing (101) continuous recognition (102) of an input made by a user (7, 100) to generate one or more interim results in the form of observations of the user (7, 100) that are stored by a system for interactive electronic communication and can be used for processing by an artificial intelligence AI (3), B) computer-implemented and AI-implemented processing (103) of the interim result on the basis of the observation or observations of the user (7, 100) stored as an interim result and generation of at least one result in the form of a mirroring and/or calibrating question in the context, C) generation (105) of one or more outputs from the system for interactive electronic communication to the user (7, 100), each comprising the mirroring and/or calibrating question from step B), then D) output (104) of the result by the system for interactive electronic communication to the user, E) capturing and storing (106, 102) the response of the user, F) classifying and assigning (107) the response of the user, and G) repeating steps A) to F) if necessary.

In some embodiments, the input made by a user (7, 100) is provided in the form of a voice input.

In some embodiments, an avatar is used as the user.

In some embodiments, a chatbot is used as the user.

In some embodiments, the continuous recognition of the input is provided in the form of a voice recognition based on natural language processing NLP.

In some embodiments, the interim result is stored in text form.

In some embodiments, the mirroring question is generated in the form of a sentence rearrangement of the input converted into text.

In some embodiments, the mirroring question is generated in the form of a repetition of the last 2 to 7 words of the input.

As another example, some embodiments include a system for interactive communication, having the following modules: at least one receiving unit (1), which is connected to a processor unit (1), which—using an AI—is designed to perform data transformation and data processing, a storage unit comprising computer program instructions (2) that are executed by the processor unit, the computer program instructions having a program code for generating one or more interim results in the form of observations on the basis of the data transformation, and the computer program instructions having access to a processor (4) comprising a program code for transforming the interim results into results in the form of questions that is able to be used to transform the interim results in the form of observations into results in the form of questions by means of sentence rearrangement, interpretation, repetition of the last 2 to 7 words, generation of calibrating questions and/or adaptation of the pronouns.

In some embodiments, the data transformation is provided by means of a processor that is configured and designed to perform natural language processing NLP.

In some embodiments, the system includes a processor that is suitable, designed and configured for the system to generate new training data for the AI of the system from the responses of the user.

In some embodiments, there is an avatar and/or a second chatbot that acts as the user in the system.

In some embodiments, the system includes a camera for face and/or gesture recognition.

As another example, some embodiments include a computer program product comprising program code means that cause a processor and/or a neural network for implementing an artificial intelligence AI to carry out one or more of the methods as described herein when the program code means are executed by the processor and/or the neural network.

As another example, some embodiments include a computer-readable storage medium comprising a computer program product as described herein.

### BRIEF DESCRIPTION OF THE DRAWINGS

Other special features and advantages of the teachings herein are apparent from the explanations of an exemplary embodiment that follow on the basis of schematic drawings. In the drawings:

FIG. 1 shows a diagram of an example system incorporating teachings of the present disclosure; and

FIG. 2 shows a flowchart for an example method of voice recognition incorporating teachings of the present disclosure.

### DETAILED DESCRIPTION

Some embodiments of the teachings herein include a computer-implemented method comprising:
A) receiving and performing continuous recognition of an input made by a user to generate one or more interim results in the form of observations of the user that are stored by a system for interactive electronic communication and can be used for processing by an artificial intelligence AI,
B) computer-implemented and AI-implemented processing of the interim result on the basis of the observation or observations of the user stored as an interim result and generation of at least one result in the form of a mirroring and/or calibrating question in the context,
C) generation of one or more outputs from the system for interactive electronic communication to the user, each comprising the mirroring and/or calibrating question from step B), then
D) output of the result by the system for interactive electronic communication to the user,
E) capturing and storing the response of the user,
F) classifying and assigning the response of the user, and
G) repeating steps A) to F) if necessary.

Some embodiments include a system for interactive communication having the following:
at least one receiving unit, which is connected to
a processor unit, which—using an AI—is designed to perform data transformation and data processing,
a storage unit comprising computer program instructions that are executed by the processor unit,
the computer program instructions having a program code for generating one or more interim results in the form of observations on the basis of the data transformation, and
the computer program instructions having access to a processor comprising a program code for transforming the interim results into results in the form of questions that is able to be used to transform the interim results in the form of observations into results in the form of questions by means of sentence rearrangement, interpretation, repetition of the last 2 to 7 words, generation of calibrating questions and/or adaptation of the pronouns.

To date, chatbots that work on the basis of rules and have stored patterns and also rules have provided the same responses to the same questions from any user. The system A.L.I.C.E. (Artificial Linguistic Internet Computer Entity) operates on the basis of a broad base of human users. If the chatbot, that is to say the system for interactive electronic communication, cannot find a response to a question from the user, it puts the question to another user and passes on this user's response to the first user. However, the system is not suited to obtaining user-specific information and training the chatbot because the chatbot learns nothing from the forwarding.

A.L.I.C.E. is a chatbot for natural language that uses an XML-DTD or Extensible Markup Language Document Type Definition called AIML (Artificial Intelligence Markup Language) to easily generate responses that are probably correct. A.L.I.C.E. was inspired by the psychotherapy program ELIZA from Joseph Weizenbaum. However, A.L.I.C.E. is not suited to obtaining user-specific information and training the chatbot because the chatbot learns nothing from the forwarding.

Teachings of the present disclosure include a chatbot comprising appropriately created AI to firstly extract an observation from an input of a user and secondly use a simple algorithm to generate from this observation a mirroring and/or calibrating question that automatically transfers a large amount of so-called user-specific soft skills that would otherwise not be able to be formulated even with the greatest outlay on modules for recognizing the emotions of the user. Simple sentence rearrangement and/or repetition and if necessary slight linguistic revision of the last few words of a sentence in most languages, but at least in German and English, allows grammatically or at least colloquially correct mirroring questions to be formulated. This can be taught to an AI of a chatbot, which then automatically continuously generates and outputs these “assimilated” questions and, on the basis of the responses, receives and classifies new training data, renders them useable as training data for itself and is thus continually developed further during operation.

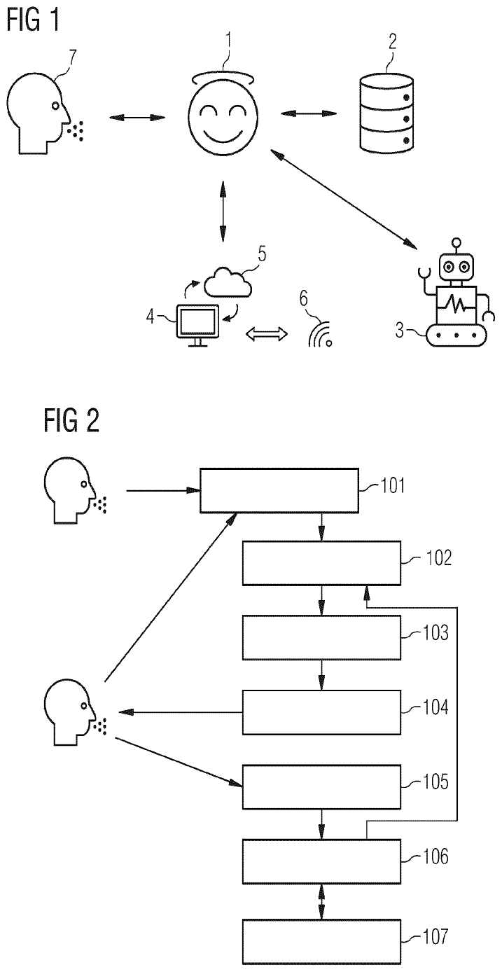

FIG. 1 shows a block diagram of an illustrative example system for interactive electronic communication incorporating teachings of the present disclosure, comprising a 1, a processor comprising the storage unit 2, an artificial intelligence 3, and a further processor 4, which is connected to the IoT 6 and/or a cloud 5, and also the user 7. Each of the arrows indicates a signal-transmitting connection between the respective modules, this being an acoustic connection in the case of the connection from the user 7 to the chatbot 1, in which at least part of the interactive electronic communication is input by way of voice by the user 7 and voice recognition by the chatbot 1, and the interactive electronic communication is output by the chatbot 1 by way of a loudspeaker (not shown) and the ears of the user 7 (not shown).

The signal-transmitting connection between the other modules 2 to 6 may be wireless and/or by cable.

The chatbot 1 is of conventional design, that is to say it comprises at least a monitor, a microphone, and/or a loudspeaker, a central circuit board on which most of the components of a calculator, computer or server are connected to one another, a CPU (Central Processing Unit) and a main memory, e.g. RAM (Random Access Memory), and also other modules known to those skilled in the art, in order to work.

The system for interactive electronic communication shown in FIG. 1 shows how the user 7 communicates with the chatbot 1 and the latter with the processor comprising the storage unit 2, the processor 4 with access firstly to the IoT 6, secondly to an AI 3 and finally to a cloud 5. The user 7 here is shown as a person, but they may also be an avatar and/or another chatbot.

FIG. 2 shows a flowchart for an illustrative example computer-implemented method incorporating teachings of the present disclosure for conducting an interactive electronic conversation.

In a first step 101, a user 100 provides an input, a voice input in the case shown, but the invention can equally involve a sound input, character input, touch and/or an image input. In the case of an image input, there may be provision, for example, for the system to comprise a camera designed such that it performs face and/or gesture recognition and makes the corresponding data available to the system as an input, so that an input, for example in the form of a voice input, from a user 100 is complemented by the face and/or gesture recognition of the user 100 for the system for the purpose of easier interpretation.

In step 102 that follows, the voice input is received and a processor of the chatbot 1 from FIG. 1, which processor is designed and suitable for this purpose, is initially used to perform voice recognition, in particular preferably based on NLP, and to store an interim result therefrom, e.g. in the processor comprising the storage unit 2 from FIG. 1. In method step 103, this interim result is forwarded to an AI—for example the AI 3 from FIG. 1—which identifies from the interim result an observation that is an essential part of the input. In method step 104, this observation is forwarded to another AI to generate either a mirroring and/or a calibrating question. The AI generates the question in method step 104 and loads it into an output device, which is a loudspeaker, a monitor, a printer or the like. The AI can also generate the question as voice or else as an image, text, characters, sound, etc. and forward it to the user by way of a suitable output device.

The output device then communicates the question to the user 100. The user responds in method step 105, the response of the user 100 being assessed as an input, which, as in method step 101, is a voice input in the case shown here, received and processed.

In some embodiments, the response of the user 100 can be received and analyzed in method step 105 and stored as an interim result in method step 106 and fed back to method step 102 to complement the interim result attained by way of method step 101, and/or stored in the system as information in method step 107. It can be stored as information by categorizing it according to various classifications, in relation to a person, in relation to a product, in relation to a location, in relation to a date, etc.

Regardless of the grammatical gender of a specific term, people with male, female or other gender identity are also covered.

In some embodiments, the recognition of the input is a voice recognition. This is in particular a natural voice recognition that, by involving an AI, artificial intelligence, analyzes and conditions human speech so that machines understand the human speech. The term natural language processing (NLP) is used in this context. NLP combines computer linguistics, that is to say rule-based modelling of human speech, with statistical, mechanical and deep learning models. These technologies together permit processors to process human speech in the form of text data and/or voice data and to understand its full significance, including the intention and/or feeling of the speaker or writer.

A key role in this case is generating the interim result. An interim result in text form is generated in the interim result—for example—from the input of the user, regardless of whether it is in the form of a voice input, a text input, a sound input, a touchscreen input and/or another input. The AI identifies in the text at least one observation that was included in the input, and stores it as an interim result. The data of the interim result are then transferred to an AI, which generates from the interim result a result in the form of a mirroring and/or calibrating question.

In some embodiments, the recognition is character recognition, for example by means of a touchscreen and/or keyboard input, by means of a scan and/or handwriting. The output by the system for interactive electronic communication can also be provided by means of voice and/or characters.

The method and system for interactive electronic communication proposed allow chatbots to learn because the reactions of a user are captured and processed. This involves in particular the captured inputs being first combined as an interim result and stored before being transformed into questions and returned to the user. The subsequent reactions and inputs are in turn recognized and processed, for example being classified, linked to the user or to similar users and/or—again by way of example—passed on to the developers of the product as feedback.

The chatbot then has different types of users, for example based on specific customer groups. As such, the chatbot has a reservoir of questions and responses for this customer class, and when a new associated user communicates with the chatbot, the chatbot develops this class of users or customers and itself further.

The source of the data for training the chatbot is the user themselves during operation, because they respond to the chatbot quite individually and therefore provide information about themselves and do not just receive best match responses from this stereotype.

Chatbots that use machine learning to conduct human-like communication use machine learning. This involves large volumes of data being made available, which are referred to as training. These data include typical user inputs and the associated responses of the chatbot. The machine learning model is then used to recognize patterns in these data and to learn from said patterns how it should react to user inputs.

There are various types of machine learning models that can be used in chatbots, for example neural networks and decision trees. Every model has its own strengths and weaknesses and is possibly better suited to certain applications than others.

It has been recognized that an optimum benefit is derived from the chatbot when its training is continuous as a process and that the chatbot is continually trained further in order to improve its performance and adapt itself to new user inputs and/or needs.

Chatbot administrators currently provide two main functions. One is input of at least 20 versions of the same question to initiate so-called NLU (Natural Language Understanding) training of intentions, e.g. “Can I eat an ice cream?”, “Have you any ice cream?”, “I really want ice cream”, etc. to coach the intention “The user would like ice cream”. The other is hard-encoded responses that the chatbot can give when such an intention is recognized, e.g. “Here you will find the next ice cream parlor”.

As a rule, this content is handed to the data scientist as unstructured prose. It is also customary for the content to be gathered from different sources in different formats before this one-stop handover moment.

A chatbot administrator is a person who is responsible for managing and maintaining a chatbot. This can involve programming, training and updating the chatbot, depending on how the chatbot is configured and what type of functions it performs.

A chatbot administrator could also be responsible for monitoring the performance of the chatbot and analyzing user inputs and responses to ensure that the chatbot delivers correct and useful responses. A chatbot administrator could also be responsible for integrating the chatbot into other systems and/or applications and ensuring that it works properly and meets the requirements of the company.

In some cases, a chatbot administrator could also be responsible for communicating with users and customers if the chatbot is unable to answer their queries or help them. In this case, the chatbot administrator would possibly interact directly with the users to answer their queries or help them to solve their problems.

All in all, the chatbot administrator is responsible for managing and maintaining the chatbot and ensuring that it works properly and provides users with useful information and services.

A data scientist is a person who is concerned with analyzing and understanding large volumes of data. Data scientists use mathematics, statistics, machine learning and other tools and techniques to recognize and understand patterns and correlations in data. They often work with large volumes of structured and unstructured data and use special tools and techniques therefor in order to process and analyze the data.

The work of a data scientist often includes analyzing data in order to support business decisions or improved processes. They can also compile predictions or forecasts by recognizing patterns in the data and presenting the results in a comprehensible form. Data scientists often work closely with other experts such as software developers and business analysts and use their knowledge of data analysis to solve complex problems and make decisions.

Data acquisition for chatbot systems is laborious and generally requires manual input by a programmer. Questions and corresponding responses are input into a chatbot CMS (e.g. Botpress) and at least 10 alternatives are found for the NLU training.

All in all, none of these methods and/or systems of known chatbot applications provide any indication of how a system for interactive electronic communication ought to be designed so that a chatbot responds on a user-specific basis. This is changed by the present invention, because a system and a method are disclosed in which a processor unit, which is suitable and designed for input recognition, in particular for voice recognition, is able to transform the observations of a user into questions and is designed such that it puts these questions to a user by way of a suitable output device.

By way of example, the following transformations take place in the processor and are then accessible to the user by way of an output device:

“System” means “system for interactive electronic communication” here

Observation of the user, that is to say input into the system:
So, my friend and I tried out an escape room.

Output from the system:
Did you and your friend try out an escape room?

Observation of the user, input into the system:
After breakfast, we went to the sauna.

Output from the system:
Did you and your friend go to the sauna after breakfast?

Input into the system:
The tool is difficult to grip in the left hand.

Output from the system:
Is the tool difficult to grip in the left hand?

Input into the system:
I find control difficult when the machine is at the window.

Output from the system:
Is control difficult when the machine is at the window?

Input into the system:
We cannot make any changes.

Output from the system:
Can't you make any changes?

Using this type of simple transformation of an observation into a question, the chatbot can request and process information from the user.

The processing in this case undergoes multiple steps; first, it can be stored and requested by other users of the same machine using a random number generator and/or it can be deposited, that is to say stored, as information relating to user X.

As such, it is possible to train a chatbot on a user-specific basis, not just on a machine-specific basis, and in particular it becomes possible to continually develop the chatbot further by means of operation, using specific observations tailored to the user.

In particular, the system is readied for using the input of the user to ask questions and for using the responses to generate a user profile. A program code, a pattern, a set of rules and/or machine learning can then deal with and respond to the future questions of the user on a user-specific basis.

In some embodiments, the system is suited to asking further questions that are in the context of the observation but do not just exactly repeat the words of the observation, so that further information about the user becomes available.

Input into the system:
The tool is difficult to grip in the left hand.

Output from the system:
How can the tool be gripped-better in the right or better in the left hand?

Input into the system:
I find control difficult when the machine is at the window.

Output from the system:
Do light conditions at the window affect control of the machine?

This method has a series of advantages: a human conversation with the chatbot, sympathetic response, but also gathering of more information and knowledge about the user. A negotiation expert will want to categorize the personality type of the negotiating partner as quickly as possible in order to find out how to best deal with them.

The teachings herein allow a chatbot to categorize the personality type of the user and also of a negotiating partner and to provide them with optimized communication, and at the same time allows the system to gather valuable KPIs (Key Performance Indicators) relating to the user. The chatbot is readied for mirroring the observations of the user and thereby conveying to the user a good feeling of “being understood”. The system therefore opens up a new dimension of understanding between the user and the system, since the user feels comfortable during communication, and for their part also understands the question, because of course it reflects and mirrors their observation. This, consciously or unconsciously for the user, provides harmony, conformity and agreement in the interactive electronic communication that extends to the content of the communication and also to the form of communication through to the choice of words.

The means for achieving the aim may be easy to achieve using an AI: it often suffices to rearrange the last three words of an input in order to generate the question.

Example input—input:
“I have three apartments of my own”

Output variation 1:
simple mirroring question from the chatbot:
“Do you have three apartments?”

Output variation 2:
restriction to the last three words to formulate the mirroring question:
“do you have apartments?”
or—colloquially—
“got three apartments of your own?”

Output variation 3:
calibrating question:
“Are you interested in real estate?”

If required, the chatbot can merely rearrange the three or four, five or 7 last “few” words in practically any way and use them to form a question that asks the user, very individually and in a personality-related manner, to say more about themselves. Grammatical correctness or colloquialism-depending on the chatbot's environment, can be chosen and set for this. The chatbot remains an automated system that, on the basis of keywords, makes classifications that in turn permit new links to other users, other products, other technologies, other teams, etc.

If e.g. a user says: “That isn't good”, the chatbot responds, “You sound pretty disappointed?”, and the user will then respond again. Or the user says: “I am picking up the children.”. The chatbot then says: “You sound as though you are a very committed parent?” and the user will gladly go into more detail.

In some embodiments, the system is calibrated and/or calibrating questions, for instance what needs to be done, for example question from the user: “Show me the nearest restaurant” Chatbot responds, “How can I do that?”, and the user will presumably respond: “Show me on the map” or “Send me an e-mail with a list”. In this way, the user has, de facto, solved the problem and specified the preferred output format. The chatbot can therefore offer an improved individualized user experience.

Combining a system for interactive electronic communication, at least one input device, a processor for recognition, a module for storage, an AI for processing and an output device allows a completely new chatbot to be provided. This chatbot continues to train on an ongoing basis, using the input of the user, in particular observations of the user, to generate data for further training and/or data for automated classification, in particular by means of mirroring, that is to say by means of accurate or rough reshaping into a question.

The input of the user can be mirrored using the same words, for example, in particular by rearranging the last three or 5 words according to quite simple rules. On the other hand, the chatbot can also ask a question just roughly or in the context and improve itself further again by means of the reactions, responses.

Finally, the chatbot can also just ask calibrated or calibrating questions and generate an output therefrom. A calibrated or calibrating question within the framework of NLP is understood to mean calibration of perception to the interlocutor, or the user. This is accomplished by recognizing their internal state by reading nonverbal signals, for example combination with gesture and/or face recognition, etc.

The mirrored response in the form of a mirroring and/or calibrating question by a chatbot that is proposed for the first time here prompts the user to continue to remain in the conversation and disclose more information about themselves. This further conversation comprising the information is then again used by means of the recognition by way of the processor and AI to automatically store a classification relating to the customer, feedback about a product categorization or a personality categorization relating to a negotiating partner in connection with the user in a memory suitable for that purpose.

What is claimed is:

1. A method for interactive electronic communication, the method comprising:
A) receiving and performing continuous recognition of input from a user to generate one or more interim results in the form of observations of the user stored by a system for interactive electronic communication and available for processing by an artificial intelligence AI;
B) computer-implemented and AI-implemented processing the one or more interim results to generate at least one result in the form of a mirroring and/or calibrating question in a context;
C) generating one or more outputs from the system for interactive electronic communication to the user, each output comprising a respective mirroring and/or calibrating question from element B);
D) communicating the one or more outputs to the user;
E) capturing and storing any response to the one or more outputs by the user; and
F) classifying and assigning the stored responses of the user.

2. The method as claimed in claim 1, wherein the user input comprises a voice input.

3. The method as claimed in claim 1, wherein the user comprises an avatar.

4. The method as claimed in claim 1, wherein the user comprises a chatbot.

5. The method as claimed in claim 1, wherein continuous recognition of the input comprises voice recognition based on natural language processing NLP.

6. The method as claimed in claim 1, wherein the interim result is stored in text form.

7. The method as claimed in claim 1, wherein the mirroring question is generated by rearranging a sentence of the input converted into text.

8. The method as claimed in claim 1, wherein the mirroring question includes repetition of a final 2 to 7 words of the input.

9. A system for interactive communication, the system comprising:
a receiving unit;
a processor in communication with the receiving unit, the processor using an AI to perform data transformation and data processing;
a memory storing computer program instructions executable by the processor,
the computer program instructions including program code to generate one or more interim results including observations based on the data transformation and
to transform the interim results into questions using sentence rearrangement, interpretation, repetition of the last 2 to 7 words, generation of calibrating questions, and/or adaptation of the pronouns.

10. The system as claimed in claim 9, wherein the processor completes the data transformation by natural language processing NLP.

11. The system as claimed in claim 9, wherein the processor generates new training data for the AI of the system from the responses of the user.

12. The system as claimed in claim 9, wherein an avatar and/or a second chatbot acts as the user in the system.

13. The system as claimed in claim 9, further comprising a camera for face and/or gesture recognition.

14-15. (canceled)
